(19) United States
(12) Patent Application Publication
(10) Pub. No.: US 2025/0074323 A1
(43) Pub. Date: Mar. 6, 2025

(54) CARGO CARRIER

(71) Applicant: MILWAUKEE ELECTRIC TOOL CORPORATION, Brookfield, WI (US)

(72) Inventors: Adam M. Schroeder, Waterford, WI (US); Danielle Newman, Menomonee Falls, WI (US)

(21) Appl. No.: 18/821,081

(22) Filed: Aug. 30, 2024

Related U.S. Application Data
(60) Provisional application No. 63/535,422, filed on Aug. 30, 2023.

(51) Int. Cl. B60R 9/06

(52) U.S. Cl. CPC B60R 9/06

(57) ABSTRACT

A cargo carrier releasably coupled to a hitch of a vehicle, the cargo carrier including: a frame including a first frame portion releasably coupled to the hitch and a second frame portion that is movable relative to the first frame portion; and a lifting assembly for alternatively raising and lowering the second frame portion relative to a grounded position, the lifting assembly including an electric motor that receives electrical current from a power source, and a drive mechanism driven by the electric motor to translate the second frame portion relative to the first frame portion to alternatively raise and lower the second frame portion relative to the grounded position, wherein the second frame portion is alternately connectable to a platform upon which cargo is storable and a power tool directly supported by the second frame portion without the platform.

### CROSS-REFERENCE TO RELATED APPLICATIONS

This application claims priority to U.S. Provisional Patent Application No. 63/535,422, filed on Aug. 30, 2023, the entire content of which is incorporated herein by reference.

### FIELD OF INVENTION

The present invention generally relates to cargo carriers that are releasably attached to a motor vehicle.

### BACKGROUND OF INVENTION

Cargo carriers are used to transport tools and equipment to and from a job site. The task of unloading and loading large tools or equipment from a vehicle is difficult. The unloading and loading of heavy items may be a burden to a user. In some cases, two or more users are required to lift the heavy tools or equipment into the vehicle. Therefore, there is a need in the art for a cargo carrier that alleviates the task of loading, unloading, and transporting tools or equipment to and from the job site. The cargo carrier also reduces the need for trailers to haul large tools or equipment.

### SUMMARY OF INVENTION

The present invention provides, in one aspect, a cargo carrier releasably coupled to a hitch of a vehicle. The cargo carrier includes a frame having a first frame portion releasably coupled to the vehicle hitch and a second frame portion that is movable relative to the first frame portion, a platform coupled to the second frame portion upon which cargo is storable, a battery pack, and a lifting assembly for alternatively raising and lowering the second frame portion and the platform relative to a grounded position. The lifting assembly includes an electric motor that receives electrical current from the battery pack, and a drive mechanism driven by the electric motor to translate the second frame portion relative to the first frame portion to alternatively raise and lower the platform relative to the grounded position.

In some aspects, the techniques described herein relate to a cargo carrier releasably coupled to a hitch of a vehicle, the cargo carrier including: a frame including a first frame portion releasably coupled to the hitch and a second frame portion that is movable relative to the first frame portion; and a lifting assembly for alternatively raising and lowering the second frame portion relative to a grounded position, the lifting assembly including an electric motor that receives electrical current from a power source, and a drive mechanism driven by the electric motor to translate the second frame portion relative to the first frame portion to alternatively raise and lower the second frame portion relative to the grounded position, wherein the second frame portion is alternately connectable to a platform upon which cargo is storable and a power tool directly supported by the second frame portion without the platform.

In some aspects, the techniques described herein relate to a cargo carrier releasably coupled to a hitch of a vehicle, the cargo carrier including: a frame including a first frame portion releasably coupled to the hitch and a second frame portion that is movable relative to the first frame portion; a platform coupled to the second frame portion upon which cargo is storable; a battery pack; and a lifting assembly for alternatively raising and lowering the second frame portion and the platform relative to a grounded position, the lifting assembly including an electric motor that receives electrical current from the battery pack, and a drive mechanism driven by the electric motor to move the second frame portion relative to the first frame portion to alternatively raise and lower the platform relative to the grounded position.

In some aspects, the techniques described herein relate to a cargo carrier releasably coupled to a hitch of a vehicle, the cargo carrier including: a frame releasably coupled to the hitch, the frame including a first segment that is fixed relative to the hitch; a second segment that is pivotably coupled to the first segment; a third segment that is pivotably coupled to the first segment; and a fourth segment that is pivotably coupled to the second segment and the third segment, the fourth segment being vertically movable relative to the first segment during which the second and third segments are maintained in a parallel relationship; and a lifting assembly for alternatively raising and lowering the fourth segment relative to a grounded position, the lifting assembly including an electric motor that receives electrical current from a power source, and a drive mechanism driven by the electric motor to translate the fourth segment relative to the first segment to alternatively raise and lower the fourth segment relative to the grounded position, wherein the fourth segment is alternately connectable to a platform upon which cargo is storable and a power tool directly supported by the second frame portion without the platform.

Other aspects of the invention will become apparent by consideration of the detailed description and accompanying drawings.

### BRIEF DESCRIPTION OF THE DRAWINGS

FIG. 1 is a top perspective view of a cargo carrier in accordance with an embodiment of the invention.

FIG. 2 is a perspective view of the cargo carrier of FIG. 1, with portions removed.

FIG. 3 is a bottom perspective view of the portion of the cargo carrier of FIG. 2.

FIG. 4 is a cross-sectional view of the portion of the cargo carrier of FIG. 1 through section 4-4 in FIG. 2.

FIG. 5 is a perspective view of a platform of the cargo carrier of FIG. 1.

FIG. 6 is a side view of a platform of the cargo carrier of FIG. 1.

FIG. 7 is a partial cross-sectional view of the cargo carrier of FIG. 1.

FIG. 8 is a perspective view of the cargo carrier of FIG. 1 including a quick release mechanism.

FIG. 9 is a perspective view of another embodiment of a cargo carrier.

FIG. 10 is a perspective view of another embodiment of a cargo carrier.

FIG. 11 is a side view of another embodiment of a cargo carrier.

FIG. 12 is a perspective view of another embodiment of a cargo carrier.

FIG. 13 is an exploded view of a cargo carrier system including a vehicle, the cargo carrier of FIG. 1, and a tool.

FIG. 14 is a perspective view of a cargo carrier system including a cargo carrier according to an embodiment of the invention and including a platform in a lowered position.

FIG. 15 is a perspective view of the cargo carrier system of FIG. 14 including the platform in an elevated position.

FIG. 16 is an exploded view of the cargo carrier system of FIG. 14.

FIG. 17 is a cross-sectional view of the cargo carrier system of FIG. 14 along the line 17-17 of FIG. 14.

FIG. 18 is a perspective view of the cargo carrier system of FIG. 14 including a tool prior to being coupled directly to the cargo carrier.

FIG. 19 is a perspective view of the cargo carrier system of FIG. 14 including the tool in the lowered position.

FIG. 20 is a perspective view of the cargo carrier system of FIG. 14 including the tool in the elevated position.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

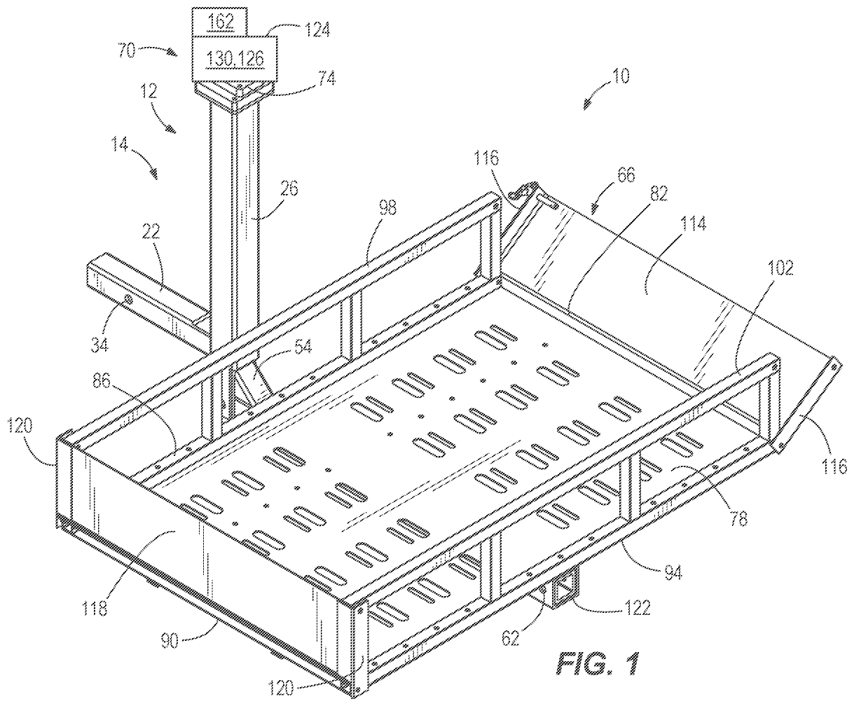

FIG. 1 illustrates a cargo carrier 10 releasably coupled to a motor vehicle. The cargo carrier 10 is configured to rigidly (e.g., lift from below) lift objects (e.g., large tools, equipment, storage boxes, materials, etc.) and move the objects to a desired height above a grounded position during transport. The cargo carrier 10 includes a frame 12 having a first frame portion 14 and a second frame portion 18 movably coupled to the first frame portion 14.

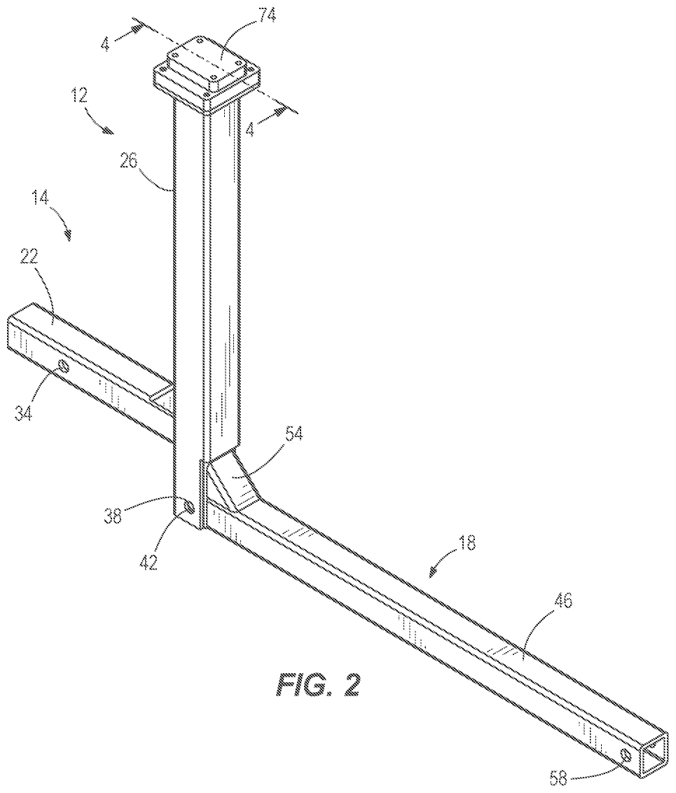

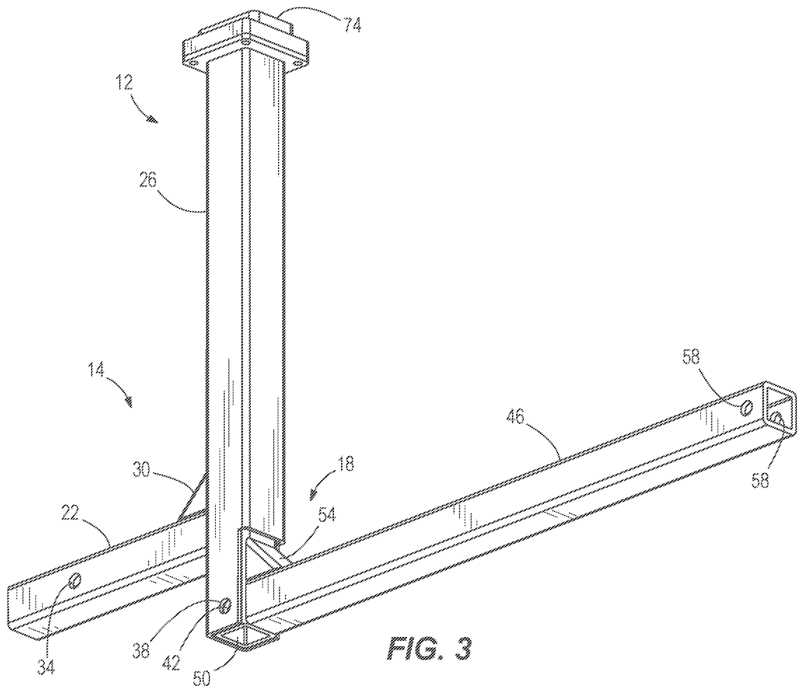

FIGS. 2 and 3 illustrate the first frame portion 14 including a substantially hollow L-shaped member having a first segment 22 and a second segment 26. The first frame portion 14 may also be referred to as a hitch. The second segment 26 extends upward from the first segment 22. In the illustrated embodiment, the second segment 26 extends upward at approximately a ninety-degree angle from the first segment 22. In other embodiments, the second segment 26 may extend upward obliquely from the first segment 22. The first segment 22 and the second segment 26 may be formed as metal tubes with a circular or square cross-sectional shape. In the illustrated embodiment, the first segment 22 and the second segment 26 are metal tubes including a square cross-sectional shape.

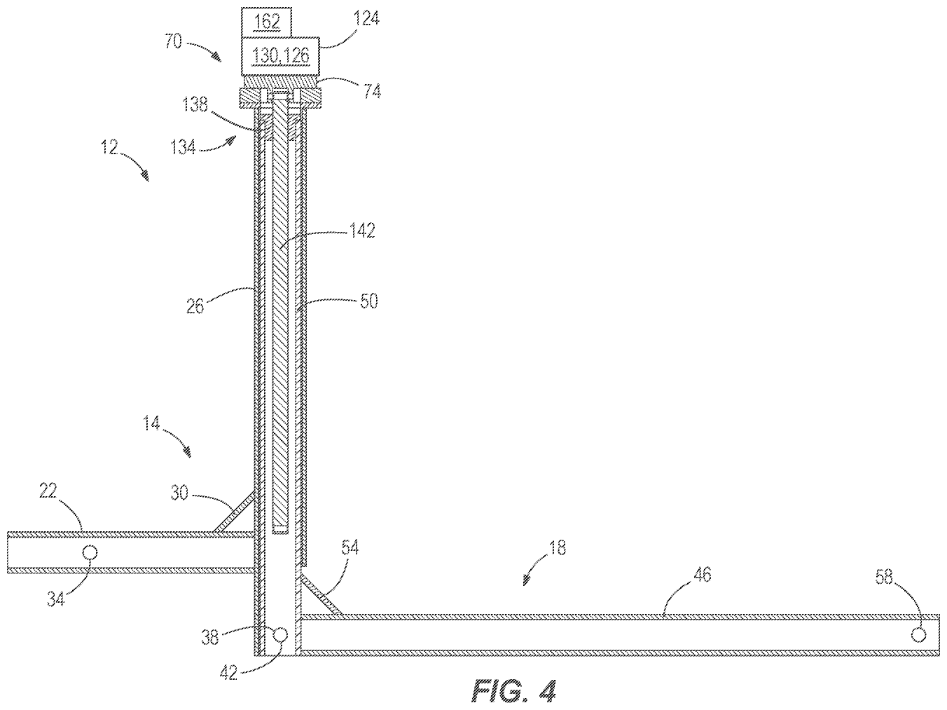

As shown in FIGS. 3 and 4, the first frame portion 14 includes a first joint 30 extending between the first segment 22 and the second segment 26. In the illustrated embodiment, the first joint 30 is angled relative to the first segment 22 or the second segment 26. The first segment 22 is attached to the second segment 26 at the first joint 30.

With continued reference to FIGS. 2 and 3, a first pair of through holes 34 are formed in the first segment 22 of the first frame portion 14, and a second pair of through holes 38 are formed in the second segment 26 of the first frame portion 14. The first segment 22 is configured to be inserted into a vehicle hitch mounted on the motor vehicle. The first segment 22 is inserted into the vehicle hitch such that the first pair of through holes 34 are aligned with holes in the vehicle hitch. A fastener such as a bolt or pin is positioned through the holes in the vehicle hitch and the first pair of through holes 34 to attach the first frame portion 14 to the vehicle hitch. As described in more detail below, a fastener is positioned through a third pair of through holes 42 formed in the second frame portion 18 and the second pair of through holes 38 to lock the second frame portion 18 relative to the first frame portion 14.

FIGS. 2 and 3 illustrate the second frame portion 18 including a substantially hollow L-shaped member having a first elongate segment 46 and a second elongate segment 50. The second elongate segment 50 extends upward from the first elongate segment 46. In the illustrated embodiment, the second elongate segment 50 extends upward at approximately a ninety-degree angle from the first elongate segment 46. In other embodiments, the second elongate segment 50 may extend upward obliquely from the first elongate segment 46. The first elongate segment 46 and the second elongate segment 50 may be formed as metal tubes with a circular or square cross-sectional shape. In the illustrated embodiment, the first elongate segment 46 and the second elongate segment 50 are metal tubes including square cross-sectional shape.

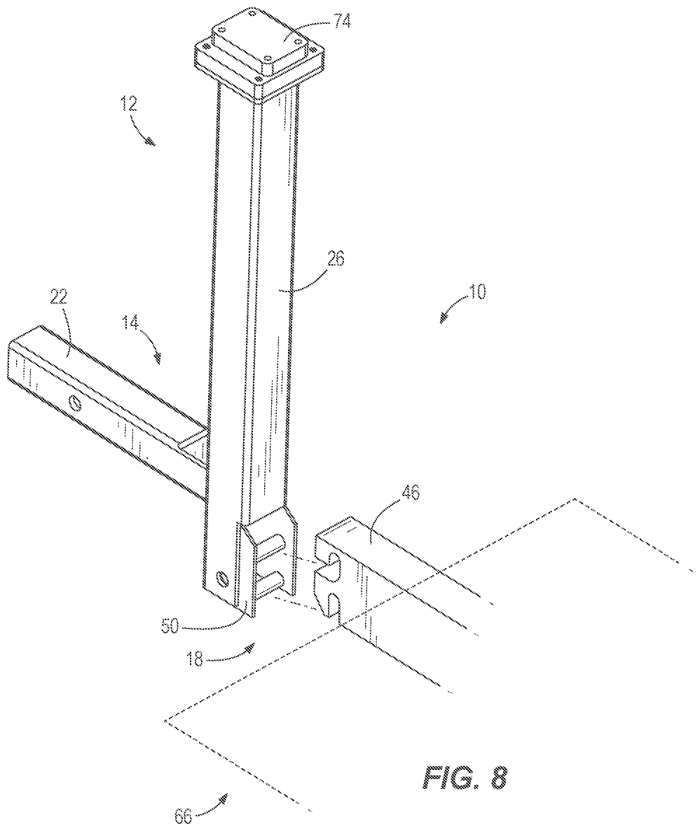

As shown in FIGS. 3 and 4, the second frame portion 18 includes a second joint 54 extending between the first elongate segment 46 and the second elongate segment 50. In the illustrated embodiment, the second joint 54 is angled relative to the first elongate segment 46 or the second elongate segment 50. The first elongate segment 46 is attached to the second elongate segment 50 at the second joint 54. In some embodiments, the first elongate segment 46 may be welded to the second elongate segment 50. In other embodiments, the first elongate segment 46 may be selectively attachable to the second elongate segment 50 by a quick release locking mechanism (e.g., clamp and cam mechanism, or pin and slot interlock mechanism) (FIG. 8).

With continued reference to FIGS. 3 and 4, the third pair of through holes 42 are formed in the second elongate segment 50 of the second frame portion 18, and a fourth pair of through holes 58 are formed in the first elongate segment 46 of the second frame portion 18. The second elongate segment 50 is configured to be inserted into the first frame portion 14, and in particular the second segment 26 of the first frame portion 14. The second elongate segment 50 is inserted into the second segment 26 of the first frame portion 14 such that the second pair of through holes 38 are aligned with the third pair of through holes 42. A fastener such as a bolt or pin is a lock and is positionable through the second pair of through holes 38 and the third pair of the through holes 42 to lock the second frame portion 18 relative to the first frame portion 14. In other embodiments, the fastener may be replaced with another type of lock configured to lock or otherwise secure the second frame portion 18 relative to the first frame portion 14. Locking the second frame portion 18 relative to the first frame portion 14 is desirable for transportation when the cargo carrier 10 is secured to the vehicle. As described in more detail below, a fastener such as a bolt or pin is positioned through the fourth pair of through holes 58 and holes 62 formed in a platform 66 to lock the platform 66 to the second frame portion 18. In other embodiments, the second frame portion 18 is configured to directly receive equipment (e.g., large tools or equipment, storage boxes, or the like) such that the equipment is directly attached to the second frame portion 18 without an intervening platform (FIG. 13).

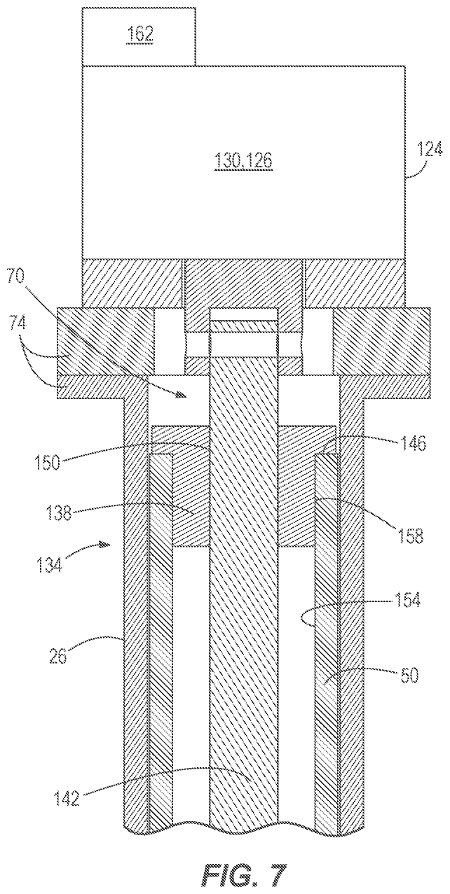

With reference to FIGS. 4 and 7, the cargo carrier 10 includes a lifting assembly 70 coupled to an end 74 of the second segment 26 of the first frame portion 14. The lifting assembly 70 extends through the second elongate segment 50 of the second frame portion 18. As described in more detail below, the lifting assembly 70 is operable to move the platform 66 relative to a grounded position. The lifting assembly 70 is operable to move the second frame portion 18 relative to the first frame portion 14 to alternatively raise and lower the platform 66 relative to a grounded position.

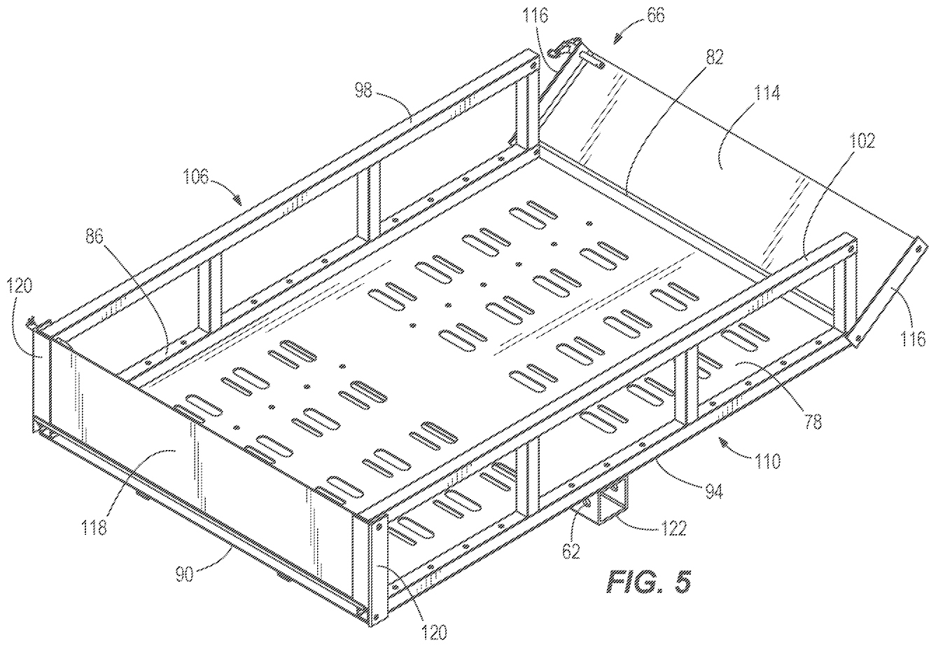

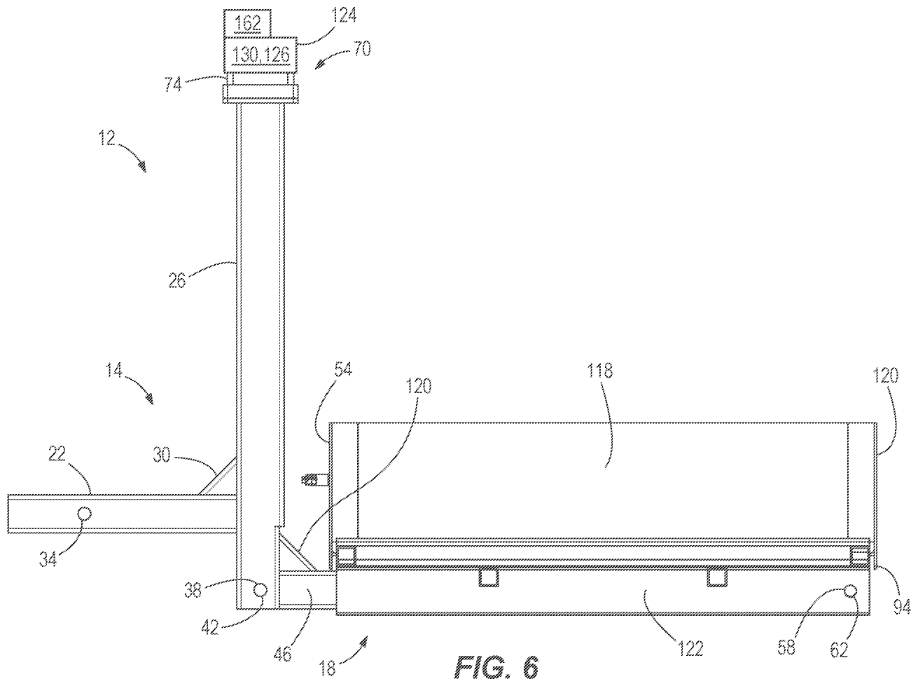

FIGS. 5 and 6 illustrate the platform 66. The platform 66 includes a floor 78 having a first end 82, a second end 86, a third end 90, and a fourth end 94. The platform 66 supports objects, tools, or cargo placed onto the platform 66.

As shown in FIG. 5, the platform 66 includes a first rail 98 and a second rail 102. In one embodiment, the first rail 98 is attached to the second end 86 of the floor 78 and the second rail 102 is attached to the fourth end 94 of the floor 78. The first rail 98 defines a first plurality of slots 106. The first plurality of slots 106 may also be referred to as a first plurality of holes. The first plurality of slots 106 may be used for placement of tie-downs to secure objects or tools to the platform 66. The second rail 102 defines a second plurality of slots 110. In other embodiments, the platform 66 may include more or fewer rails attached to the first end 82, the second end 86, the third end 90, and the fourth end 94.

With continued reference to FIG. 5, the platform 66 includes a first ramp 114 and a second ramp 118. The first ramp 114 includes first ramp distal ends 116 and the second ramp 118 includes second ramp distal ends 120 (FIG. 5). The second ramp 118 is identical to the first ramp 114. In one embodiment, the first ramp 114 is attached to the first end 82 of the floor 78 and the second ramp 118 is attached to the third end 90 of the floor 78. The first ramp 114 is pivotable relative to the floor 78 of the platform 66. The second ramp 118 is pivotable relative to the floor 78 of the platform 66. The first ramp 114 and the second ramp 118 are adjustable between a deployed position, in which the first ramp 114 extends between the platform 66 and the ground, and a stowed position. The second ramp 118 may also be adjustable between a deployed position, in which the second ramp 118 extends between the platform 66 and the ground, and a stowed position. When in the stowed position, the first ramp distal ends 116 may be secured to the rails 98, 102 by a quick-release mechanism (e.g., clamp and cam mechanism), fasteners, pins, or the like. Similarly, the second ramp distal ends 120 may be secured to the rails 98, 102 by a quick-release mechanism (e.g., clamp and cam mechanism), fasteners, pins, or the like. The first ramp 114 and the second ramp 118 improve the case of loading and unloading objects or tools from the platform 66.

With reference to FIGS. 5 and 6, the platform 66 also includes a receiver 122 that is configured to be coupled to the frame 12. In particular, the receiver 122 is configured to be coupled to the first elongate segment 46 of the second frame portion 18. In the illustrated embodiment, the receiver 122 is a metal tube including a square cross-sectional shape that corresponds with the square cross-sectional shape of the first elongate segment 46 of the second frame portion 18. The receiver 122 of the platform 66 receives the first elongate segment 46 of the second frame portion 18. The receiver 122 defines the holes 62 that correspond with the fourth pair of through holes 58 of the second frame portion 18. A fastener such as a bolt or a pin is inserted through the holes 62 in the receiver 122 and the fourth pair of through holes 58 to secure or lock the platform 66 to the second frame portion 18.

Now with reference to FIG. 7, the lifting assembly 70 is illustrated in more detail. The lifting assembly 70 is attached to the end 74 of the second segment 26 of the first frame portion 14. The lifting assembly 70 also extends into the second elongate segment 50 of the second frame portion 18. The lifting assembly 70 is operable to alternatively raise and lower the second frame portion 18 relative to the first frame portion 14 thereby alternatively raising and lowering the platform 66 relative to a grounded position. The lifting assembly 70 receives power from a battery pack 126. In other embodiments, the lifting assembly 70 receives 12 V auxiliary power from a plug on the vehicle. The battery pack 126 is rechargeable. The battery pack 126 is removable and interchangeable for use with a plurality of power tools in a power tool system all using the same battery pack 126 (e.g., battery pack 126 may be used to power a power tool such as a drill, and then used to power the lifting assembly 70 of the cargo carrier 10). The battery pack 126 includes a battery chemistry such as, Lithium (“Li”), Lithium-ion (“Li-ion”), other Lithium-based chemistry, or other rechargeable battery chemistry.

As shown in FIGS. 4 and 7, a housing 124 is attached to the end 74 of the first frame portion 14. The lifting assembly 70 includes an electric motor 130 and a drive mechanism 134. The housing 124 may house the electric motor 130 and include a battery pack receptacle configured to receive the battery pack 126. The housing 124 may also house a portion of the drive mechanism 134. The electric motor 130 is a brushless direct-current (BLDC) electric motor. In one example, the electric motor 130 may be used with a battery pack 126 having a nominal voltage of 12 V. In another example, the electric motor 130 can be used with a battery pack 126 having a nominal voltage of 18 V. The battery pack 126 may have any suitable nominal voltage.

With reference to FIGS. 4 and 7, the drive mechanism 134 includes an insert 138 and a threaded rod 142. The insert 138 is received in an end 146 of the second elongate segment 50. The insert 138 defines a threaded aperture 150. The threaded aperture 150 receives the corresponding threaded rod 142 extending from the end 74 of the first frame portion 14. The threaded rod 142 is coupled to the electric motor 130. A portion of the second elongate segment 50 of the second frame portion 18 is received by the second segment 26 of the first frame portion 14 to allow the second frame portion 18 to axially translate relative to the first frame portion 14.

As shown in FIG. 7, the second elongate segment 50 includes an inner surface 154 and the insert 138 includes an outer surface 158. The inner surface 154 of the second elongate segment 50 is configured to receive the outer surface 158 of the insert 138. The inner surface 154 of the second elongate segment 50 includes a cross-sectional shape that is substantially square. The insert 158 is fixedly coupled to the second elongate segment 50 of the second frame portion 18. The insert 158 may be welded to the second elongate segment 50. Accordingly, the second frame portion 18 cannot rotate relative to the first frame portion 14. Additionally or alternatively to being welded, the outer surface 158 of insert 138 may include a cross-sectional shape that is substantially square corresponding to the inner surface 154 of the second elongate segment 50. The cross-sectional shapes of the inner surface 154 and the outer surface 158 may restrict rotation of the second frame portion 18 relative to the first frame portion 14. In the illustrated embodiment, the inner surface 154 of the second elongate segment 50 and the outer surface 158 of the insert 138 include a square cross-sectional shape. In other embodiments, the cross-sectional shape of the inner surface 154 and the outer surface 158 may be any shape capable of restricting rotational motion between the second frame portion 18 and the first frame portion 14. For example, the cross-sectional shape of the inner surface 154 and the outer surface 158 may be a polygon or a shape with at least one curved surface such as a semi-circle, triangle, rectangle, pentagon, or hexagon. The insert 138 may be fixedly coupled to the second segment 50 of the second frame portion 18 in any suitable way in other embodiments.

As shown in FIGS. 4 and 7, the cargo carrier 10 includes a user interface 162 on the housing 124 that is operable to start the electric motor 130 of the lifting assembly 70. The user interface 162 is operable to selectively operate the electric motor 130 to alternatively raise and lower the platform 66 relative to a grounded position. In some embodiments, the user interface 162 may include any number of user controls, such as switches, buttons, levers, etc. that permit the user to operate the cargo carrier 10. Specifically, the user interface 162 is operable to control the vertical movement of the second frame portion 18 and the platform 66 relative to the grounded position.

In operation, to lower the platform 66 from an elevated position to the grounded position, a user operates controls on the user interface 162 to activate the electric motor 130, which receives electrical current from the battery pack 126. The electric motor 130 provides torque to the threaded rod 142 to rotate the threaded rod 142 in a first rotational direction. The threads of the threaded rod 142 cooperate with the threads of the threaded aperture 150 in the insert 138. Because the insert 138 is fixedly coupled to the second elongate segment 50 of the second frame portion 18, the insert 138 cannot rotate relative to the second segment 50 of the first frame portion 14. Accordingly, rotation of the threaded rod 142 drives the insert 138 axially relative to the second segment 26 of the first frame portion 14. As the threaded rod 142 rotates in the first rotational direction, the insert 138 and the second elongate segment 50 move away from the end 74 of the second segment 26. The insert 138 and the second frame portion 18 move together and away from the end 74 of the second segment 26. The insert 138 is positioned away from the end 74 of the second segment 26 in a lowered position. When the insert 138 is in the lowered position, the platform 66 may be at or near the grounded position. A user may place cargo, objects, or tools onto the platform 66 in the lowered position. Further, the first ramp 114 and/or the second ramp 118 may be adjusted from the stowed position to the deployed position when the platform 66 is in the lowered position to facilitate loading cargo, objects, or tools onto the platform 66.

Similarly, to raise the platform 66 from the lowered position, the user operates controls on the user interface 162 to re-activate the electric motor 130. The electric motor 130 provides torque to the threaded rod 142 to rotate the threaded rod 142 in a second rotational direction that is opposite the first rotational direction. As the threaded rod 142 rotates in the second rotational direction, the insert 138 and the second elongate segment 50 move toward the end 74 of the second segment 26. The insert 138 and the second elongate segment 50 move together toward towards the end 74 of the second segment 26. Once the platform 66 is at the desired height (e.g., 12 inches), the user deactivates the electric motor 130 via the user interface 162 to maintain the platform in the elevated position. The user may insert a fastener through the second pair of through holes 38 and the third pair of through holes 42 to lock the second frame portion 18 relative to the first frame portion 14 during transportation.

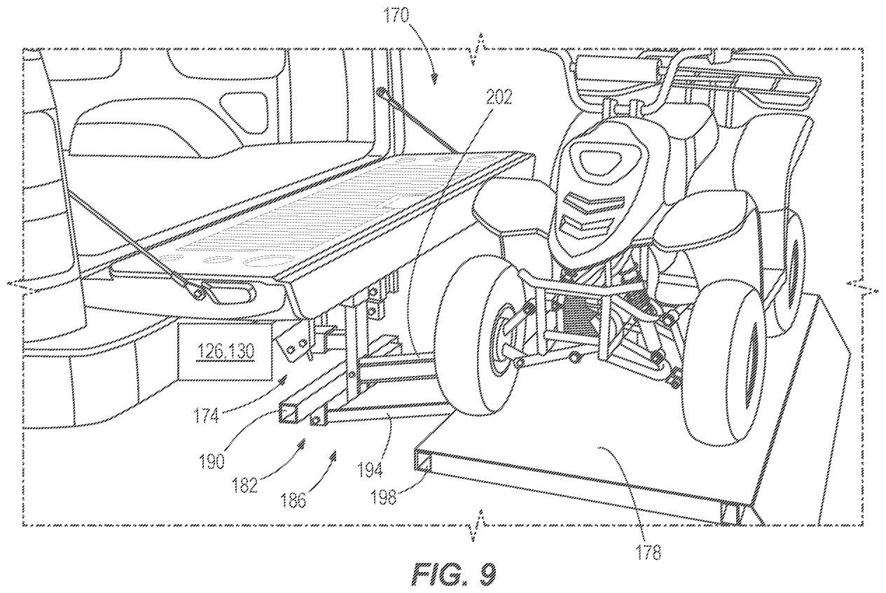

FIG. 9 illustrates another embodiment of a cargo carrier 170 including a frame 174, a platform 178, and a drive mechanism 182. The frame 174 is attached to a vehicle by fasteners, a quick release mechanism, or the like. The platform 178 is attached to the frame 174, and the drive mechanism 182 drives the platform 178. The drive mechanism 182 includes a four-bar linkage system 186 driven by the electric motor 130 powered by the battery pack 126. In some embodiments, the electric motor 130 drives a geartrain that is coupled to the four-bar linkage system 186. In other embodiments, the electric motor 130 drives a winch including a spool and a cable, in which, the four-bar linkage system 186 is coupled to the cable. The four-bar linkage system 186 includes a first link 190, a second link 194, a third link 198, and a fourth link 202. The first link 190 is attached to the frame 174, the third link 198 is attached to the platform 178, and the second and fourth links 194, 202 respectively extend therebetween. The electric motor 130 is configured to alternatively rotate the second and fourth links 194, 202 respectively between a first rotational direction or a second rotational direction opposite the first direction for raising and lowering the third link 198, to which the platform 178 is attached, relative to a grounded position.

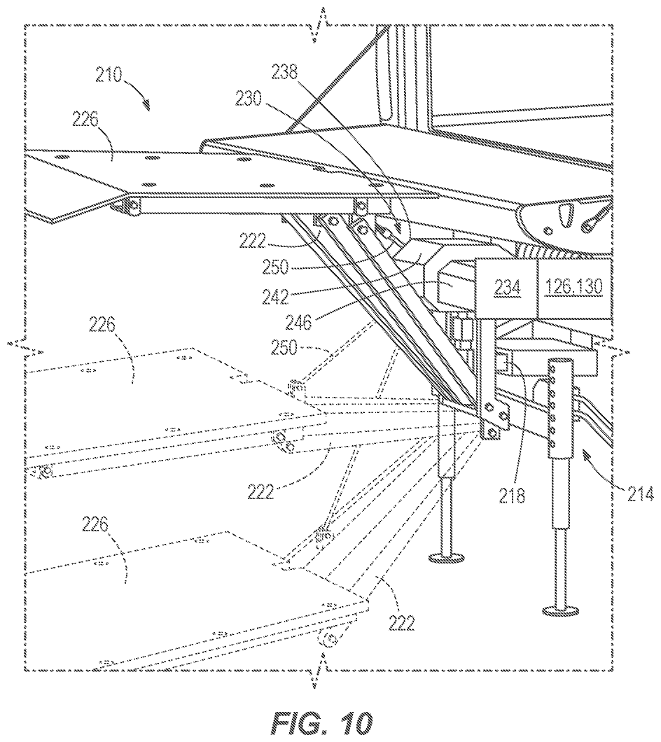

FIG. 10 illustrates another embodiment of a cargo carrier 210 including a frame 214 having a first frame portion 218 and a second frame portion 222, a platform 226, and a drive mechanism 230. The drive mechanism 230 includes a gearbox assembly 234 and a winch 238 driven by the electric motor 130 powered by the battery pack 126. The winch 238 includes a spool 242 driven by a rotary shaft 246 and a cable 250 wound around the spool 242 and coupled to the second frame portion 222, in which, the platform 226 is attached to the second frame portion 222. The electric motor 130 is configured to alternatively wind and unwind the cable 250 for raising and lowering the platform 226 relative a grounded position. In the illustrated embodiment, the cable 250 is affixed to the second frame portion 18, to which the platform 226 is attached, for alternatively raising and lowering the platform 226 relative to the grounded position. The gearbox assembly 234 is positioned between and is operable to connect the electric motor 130 and the winch 238.

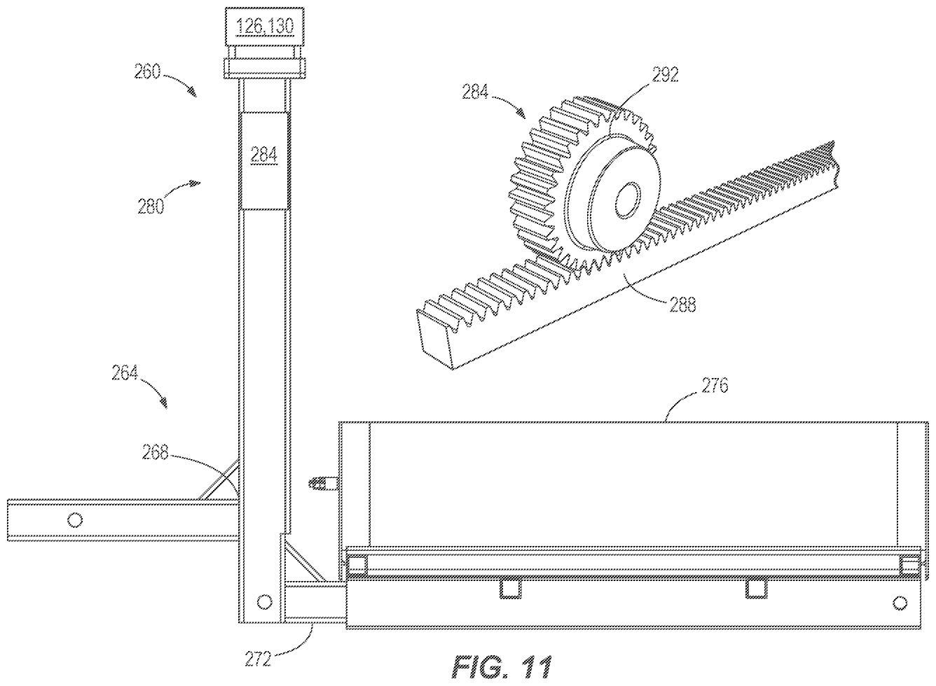

FIG. 11 illustrates another embodiment a cargo carrier 260 including a frame 264 having a first frame portion 268 and a second frame portion 272, a platform 276, and a drive mechanism 280. The drive mechanism 280 includes a gear train 284 driven by the electric motor 130 powered by the battery pack 126. The gear train 284 may be positioned in the frame 264. In some embodiments, the drive mechanism 280 includes a rack 288 and a pinion 292. In other embodiments, the drive mechanism 280 includes a gear train 284 having a plurality of gears. In the illustrated embodiment, the pinion 292 may be positioned in the first frame portion 268 and the rack 288 may positioned in the second frame portion 272. The pinion 292 rotatably engages the rack 288 to allow the rack 288 to translate relative to the pinion 292, thereby allowing the second frame portion 272 to move relative to the first frame portion 268. The pinion 292 is driven by the electric motor 130. The electric motor 130 is configured to alternatively rotate the pinion 292 in a first rotational direction or a second rotational direction opposite the first rotational direction for raising and lowering the second frame portion 272, to which the platform 276 is attached, relative to a grounded position.

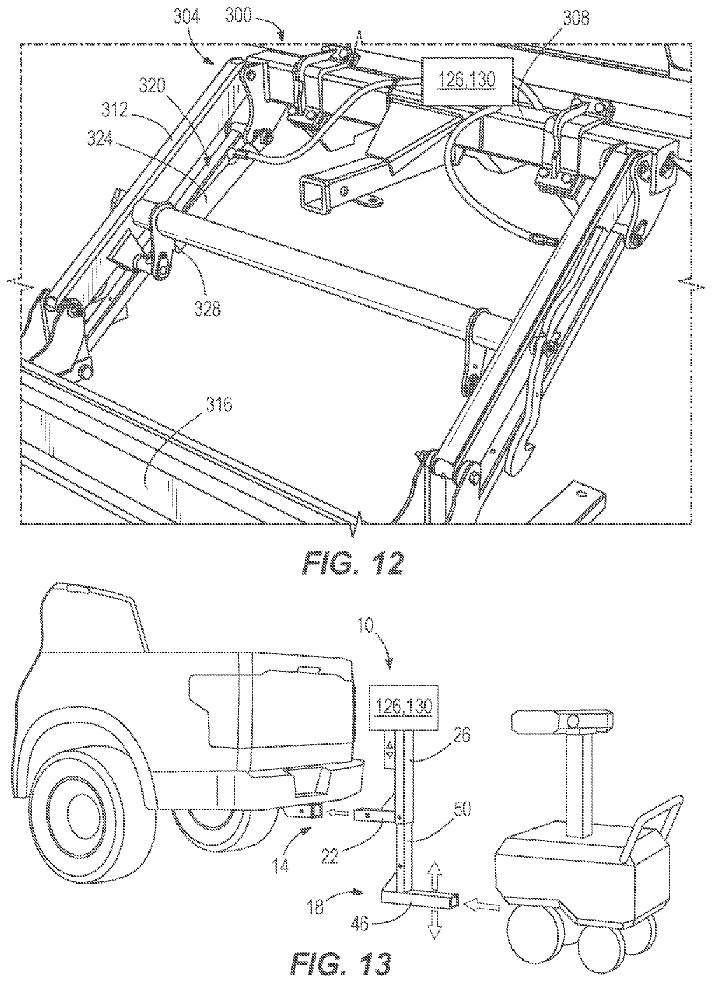

FIG. 12 illustrates another embodiment of a cargo carrier 300 including a frame 304 having a first frame portion 308 and a second frame portion 312, a platform 316, and a drive mechanism 320. The drive mechanism 320 is driven by the electric motor 130 powered by the battery pack 126. The first frame portion 308 may include a horizontal bar portion. The second frame portion 312 may include a H-bar frame portion. The drive mechanism 320 includes a hydraulic system having fluid (e.g., oil) that is pumped to an elevated pressure to generate movement. In some embodiments, the electric motor 130 pumps a fluid into a cylinder 324 to move a piston 328, to which the second frame portion 312 is attached. The drive mechanism 320 may include a valve to control the flow of the fluid into and out of the cylinder 324 (not shown). In other embodiments, the hydraulic system may include more than one cylinder 324, piston 328, and/or valve (not shown). The drive mechanism 320 is configured to alternatively raise and lower the second frame portion 312 for raising and lowering the platform 316 relative to a grounded position.

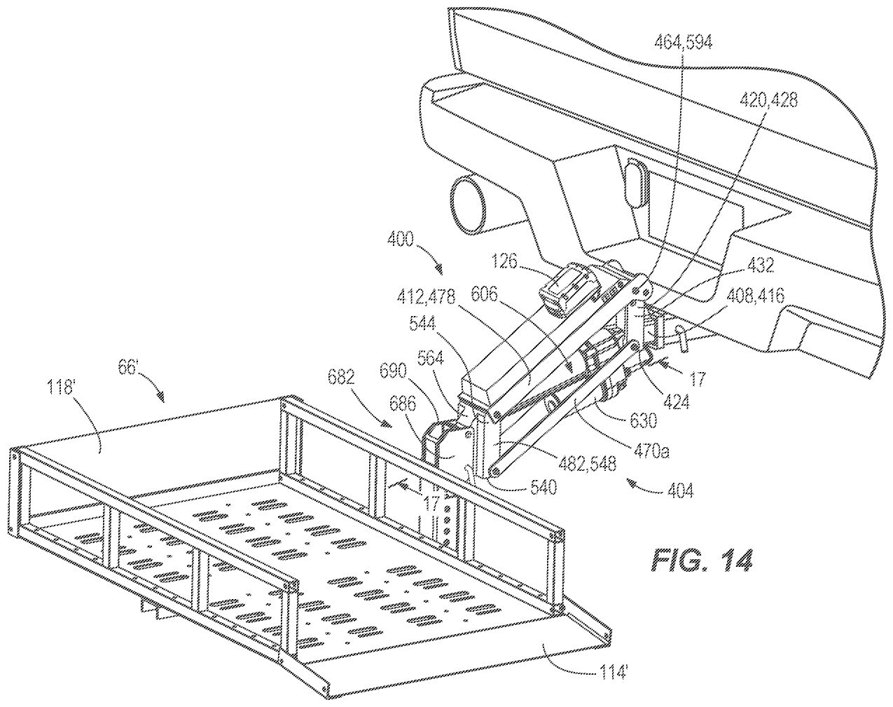

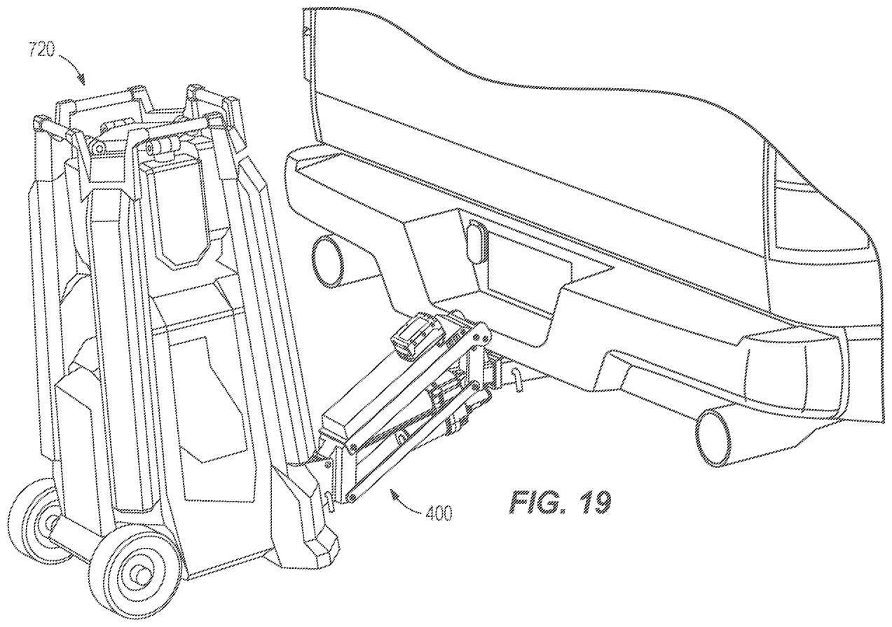

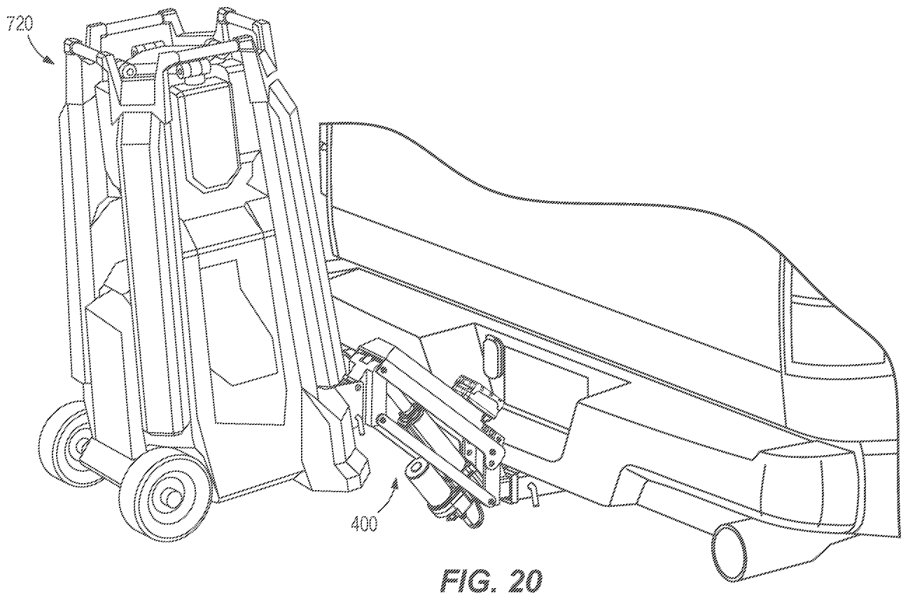

FIGS. 14-20 illustrate a cargo carrier 400 according to another embodiment. As shown in FIG. 14, the cargo carrier 400 includes a frame 404 having a first frame portion 408 and a second frame portion 412 movably coupled to the first frame portion 408. The first frame portion 408 includes a first segment 416 and a second segment 420. In the illustrated embodiment, the second segment 420 has a first end 424 and a second end 428 opposite the first end 424. As shown, the first segment 416 is integrally formed with (or otherwise coupled to) the second segment 420 at or adjacent the first end 424. The second segment 420 therefore extends upward from the first segment 416. In the illustrated embodiment, the second segment 420 extends upward at approximately a ninety-degree angle from the first segment 416. In other embodiments, the second segment 420 may extend upward obliquely from the first segment 416.

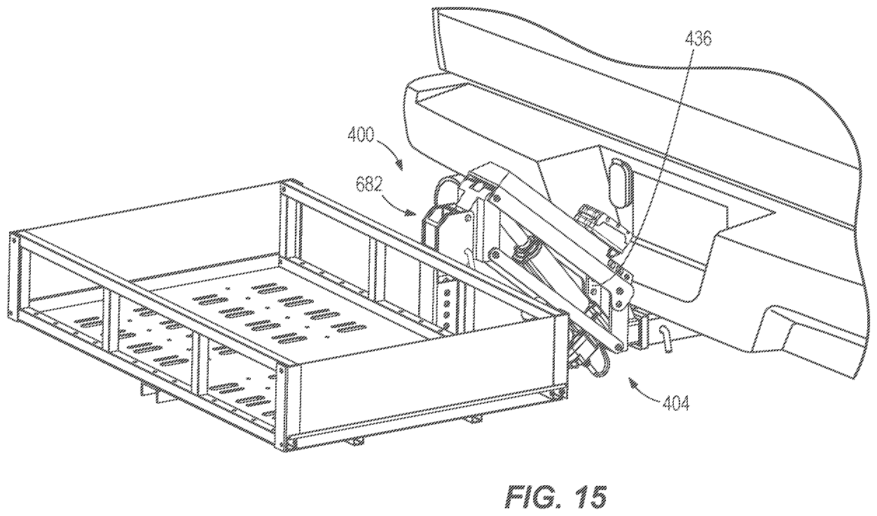

As shown, the first segment 416 is a substantially hollow tube. The first segment 416 may be a metal tube with a circular or square cross-sectional shape. In the illustrated embodiment, the first segment 416 is a metal tube including a square cross-sectional shape. As shown, the second segment 420 includes a first wall 432 and a second wall 436 (FIG. 15).

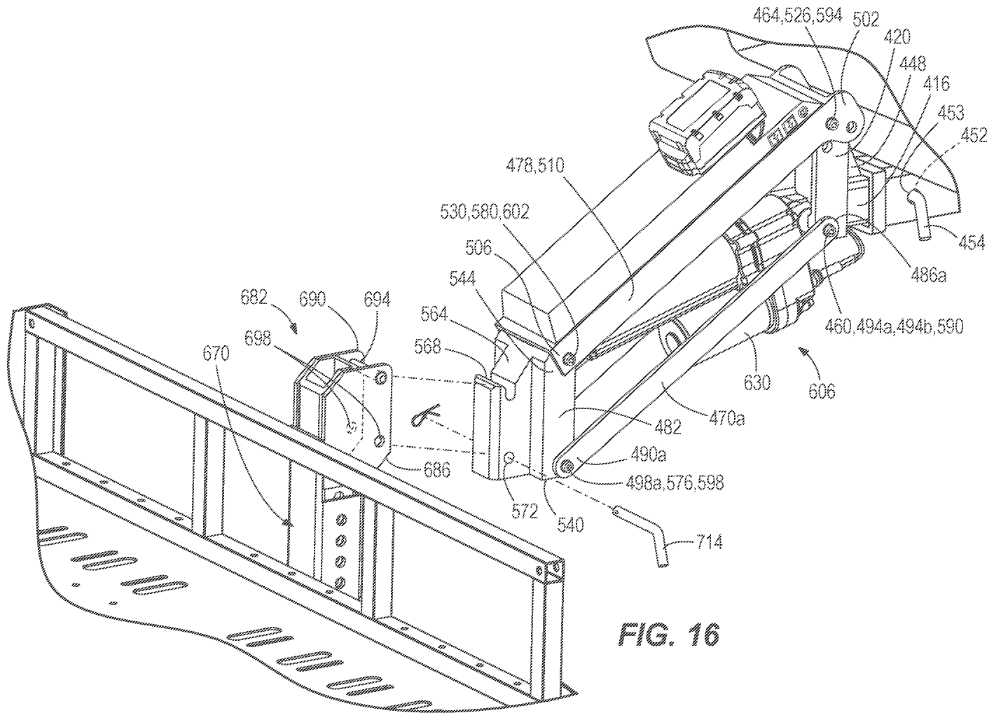

As shown in FIG. 16, the first frame portion 408 includes a first joint 448 extending between the first segment 416 and the second segment 420. In the illustrated embodiment, the first joint 448 is angled relative to the first segment 416 or the second segment 420. The first segment 416 is attached to the second segment 420 at the first joint 448.

With continued reference to FIG. 16, a first pair of through holes 452 are formed in the first segment 416 of the first frame portion 408. The first segment 416 is configured to be inserted into a vehicle hitch mounted on the motor vehicle. The first segment 416 is inserted into the vehicle hitch such that the first pair of through holes 452 are aligned with holes 453 in the vehicle hitch. A fastener 454 such as a bolt or pin is positioned through the holes in the vehicle hitch and the first pair of through holes 452 to attach the first frame portion 408 to the vehicle hitch.

Additionally, a first pair of through holes 460 and a second pair of through holes 464 are formed in the second segment 420 of the first frame portion 408. The first pair of through holes 460 is positioned at or adjacent to the first end 424. One of the through holes 460 extends through the first wall 432 and is aligned with the other of the through holes 460, which extends through the second wall 436. The second pair of through holes 464 is positioned at or adjacent to the second end 428. One of the through holes 464 extends through the first wall 432 and is aligned with the other of the through holes 464, which extends through the second wall 436.

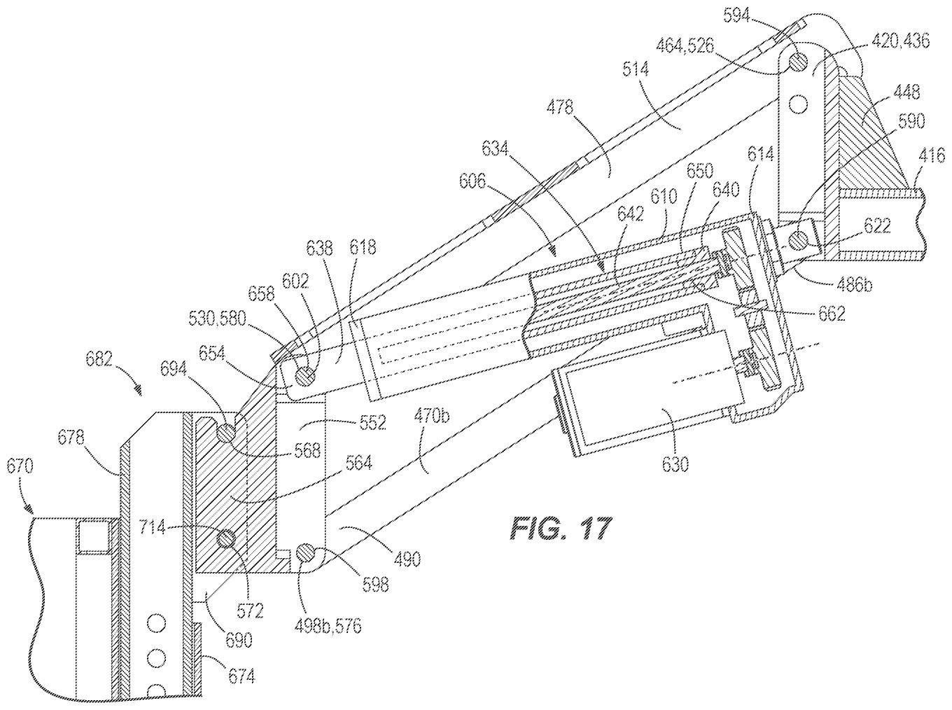

FIG. 14 illustrates the second frame portion 412 including a first segment 470a, a second segment 470b (FIG. 17), a third segment 478, and a fourth segment 482. The first segment 470a, the second segment 470b, and third segment 478 are coupled between the second segment 420 of the first frame portion 408 and the fourth segment 482.

With respect to FIGS. 16 and 17, each of the first and second segments 470a, 470b includes a first end 486a, 486b and a second end 490a, 490b opposite the first end 486a, 486b. The first end 486a, 486b of each of the first and second segments 470a, 470b includes a first through hole 494a, 494b and the second ends 490a, 490b of each of the first and second segments 470a, 470b includes a second through hole 498a, 498b. In other embodiments, the first and second segments 470a, 470b could be replaced with a unitary first segment including a first pair of aligned through holes and a second pair of aligned through holes, as will be discussed below relative to the third segment 478.

The third segment 478 includes a first end 502 and a second end 506 opposite the first end 502. The third segment 478 includes a first wall 510 and a second wall 514 (FIG. 17).

As shown, a first pair of through holes 526 and a second pair of through holes 530 are formed in the third segment 478 of the second frame portion 412. The first pair of through holes 526 is positioned at or adjacent to the first end 502. One of the through holes 526 extends through the first wall 510 and is aligned with the other of the through holes 526, which extends through the second wall 514. The second pair of through holes 530 is positioned at or adjacent to the second end 506. One of the through holes 530 extends through the first wall 510 and is aligned with the other of the through holes 530, which extends through the second wall 514.

The fourth segment 482 includes a first end 540 and a second end 544 opposite the first end 540. The fourth segment 482 includes a first wall 548 and a second wall 552. A projection 564 extends outwards from the fourth segment 482. The projection 564 includes a recess or groove 568 and a through hole 572. The projection 564 defines a first interface, which will be discussed in greater detail below.

As shown, a first pair of through holes 576 and a second pair of through holes 580 are formed in the fourth segment 478 of the second frame portion 412. The first pair of through holes 576 is positioned at or adjacent to the first end 540. One of the through holes 576 extends through the first wall 548 and is aligned with the other of the through holes 576, which extends through the second wall 552. The second pair of through holes 580 is positioned at or adjacent to the second end 544. One of the through holes 580 extends through the first wall 548 and is aligned with the other of the through holes 580, which extends through the second wall 552.

As shown, the first pair of through holes 460 of the second segment 420 of the first frame portion 408 is aligned with the first through hole 494a, 494b of the first and second segments 470a, 470b of the second frame portion 412. Similarly, the first pair of through holes 576 of the fourth segment 482 of the second frame portion 412 is aligned with the second through holes 498a, 498b of the first and second segments 470a, 470b of the second frame portion 412. A fastener 590 extends through the aligned through holes 460, 494a, 494b to pivotably couple the first and second segments 470a, 470b of the second frame portion 412 to the second segment 420 of the first frame portion 408. A fastener 594 extends through the aligned through holes 498a, 498b, 576 to pivotably couple the first, second, and fourth segments 470a, 470b, 482 of the second frame portion 412.

Additionally, the first pair of through holes 526 of the third segment 478 of the second frame portion 412 is aligned with the second pair of through holes 464 of the second segment 420 of the first frame portion 408. Similarly, the second pair of through holes 530 of the third segment 478 of the second frame portion 412 is aligned with the second pair of through holes 580 in the fourth segment 482 of the second frame portion 412. A fastener 598 extends through the aligned through holes 464, 526 to pivotably couple the third segment 478 of the second frame portion 412 to the second segment 420 of the first frame portion 408. A fastener 602 extends through the aligned through holes 530, 580 to pivotably couple the third and fourth segments 478, 482 of the second frame portion 412.

Collectively, the second segment 420 of the first frame portion 408 and the first, second, third, and fourth segments 470a, 470b, 478, 482 of the second frame portion 412 are configured as a four-bar linkage. More specifically, the first, second, and third segments 470a, 470b, 478 are pivotably coupled to the second segment 420 of the first frame portion 408 and fourth segment 482 of second frame portion 412 about axes defined by the fasteners 590, 594, 598, 602 such that the fourth segment 482 of the second frame portion 412 is translatable relative to the second segment 420 of the first frame portion 408. In the illustrated embodiment, the second segment 420 of the first frame portion 408 is substantially parallel to the fourth segment 482 of the second frame portion 412. The first segment 470a and the second segment 470b of the second frame portion 412 are substantially parallel to the third segment 478 of the second frame portion 412. Further, in the illustrated embodiment, the fourth segment 482 of the second frame portion 412 is movable parallel relative to the second segment 420 of the first frame portion 408. In other embodiments, the second segment 420 of the first frame portion 408 may be positioned at a non-parallel angle relative to the fourth segment 482 of the second frame portion 412. In still other embodiments, the first segment 470a and the second segment 470b of the second frame portion 412 may be positioned at a non-parallel angle relative to the third segment 478 of the second frame portion 412. In still other embodiments, in the illustrated embodiment, the fourth segment 482 of the second frame portion 412 is movable at a non-parallel angle relative to the second segment 420 of the first frame portion 408.

With reference to FIGS. 14-17, the cargo carrier 10 includes a lifting assembly 606 coupled between the first frame portion 408 and the second frame portion 412. As described in more detail below, the lifting assembly 606 is operable to move the second frame portion 412 relative to the ground. The lifting assembly 606 is operable to move the second frame portion 412 relative to the first frame portion 408 to alternatively raise and lower the second frame portion 412 relative to the ground. The lifting assembly 606 receives power from a battery pack 126. In other embodiments, the lifting assembly 606 receives 12 V auxiliary power from a plug on the vehicle. The battery pack 126 is rechargeable. The battery pack 126 is removable and interchangeable for use with a plurality of power tools in a power tool system all using the same battery pack 126 (e.g., battery pack 126 may be used to power a power tool such as a drill, and then used to power the lifting assembly 606 of the cargo carrier 10). The battery pack 126 includes a battery chemistry such as, Lithium (“Li”), Lithium-ion (“Li-ion”), other Lithium-based chemistry, or other rechargeable battery chemistry.

As shown in FIG. 17, a housing 610 is pivotably coupled to and extends from second segment 420 of the first frame portion 408. As shown, the housing 610 includes a first end 614 that is pivotably coupled to the second segment 420 and a second end 618 that is spaced apart from the first end 614. The first end 614 of the housing 610 includes a through hole 622 that is aligned with the first pair of through holes 460 of the second segment 420 of the first frame portion 408 and the first and second segments 470a, 470b of the second frame portion 412. Accordingly, the through hole 622 of the housing 610 also receives the fastener 590, noted above. Accordingly, the first end 614 of the housing 610 is pivotable about the axis defined by the fastener 590.

The lifting assembly 606 includes an electric motor 630 and a drive mechanism 634. The housing 610 may at least partially house the electric motor 630. The housing 610 may also house a portion of the drive mechanism 634. The electric motor 630 is a brushless direct-current (BLDC) electric motor. In one example, the electric motor 630 may be used with a battery pack 126 having a nominal voltage of 12 V. In another example, the electric motor 630 can be used with a battery pack 126 having a nominal voltage of 18 V.

A battery pack receptacle (not shown) may be included in the second frame portion 412, as in the illustrated embodiment, or in the housing 610 of the lifting assembly 606. The battery pack receptacle is configured to receive the battery pack 126 and enable electrical communication between the battery pack 126 and the motor 630.

The drive mechanism 634 includes an extensible rod 638, an insert or nut 640 fixedly coupled to the extensible rod 638, and a threaded rod 642 configured to engage the insert and operable by the motor 630.

The extensible rod 638 is pivotably coupled to the second frame portion 412. The extensible rod 638 is hollow and has a first end 650 positioned within the housing 610 and a second end 654 pivotably coupled to the fourth segment 482 of the second frame portion 412. As shown, the second end 654 of the extensible rod 638 includes a through hole 658 that is aligned with the through holes 530, 580 of the third and fourth segments 478, 482 of the second frame portion 412. The through hole 658 of the extensible rod 638 also receives the fastener 602, noted above. Accordingly, the second end 654 of the extensible rod 638 is pivotable about the axis defined by the fastener 602.

The insert 640 is fixedly coupled to the first end 650 of the extensible rod 638 is received within the housing 610 in a similar manner that the insert 138 is fixedly coupled to the second elongate segment 50 of FIG. 7. The insert 640 defines a threaded aperture 662. The threaded aperture 662 is configured to matingly receive the threaded rod 642, which is positioned within the housing 610. The threaded rod 642 is operably coupled to and rotatable by the motor 630. Rotation of the threaded rod 642 causes translation of the extensible rod 638 via engagement between the threaded rod 642 and the insert 640.

In other embodiments, the insert 640 and the threaded rod 642 may be replaced by a hydraulic system that is in communication with the motor 630 to translate the extensible rod 638.

The cargo carrier 400 includes a user interface (not shown) on the housing 610 that is operable to start the electric motor 630 of the lifting assembly 606. The user interface is operable to selectively operate the electric motor 630 to alternatively raise and lower the second frame portion 412 relative to the first frame portion 408. In some embodiments, the user interface may include any number of user controls, such as switches, buttons, levers, etc. that permit the user to operate the cargo carrier 400. Specifically, the user interface is operable to control the vertical movement of the second frame portion 412 relative to the grounded position.

As shown in FIGS. 14-16, a platform 66′ may be releasably coupled to the frame 404. The platform 66′ of FIGS. 14-16 is similar to the platform of FIGS. 1 and 5. Therefore, like reference structure will be noted with like reference numerals with a prime (′) and only the differences will be discussed. As shown, the platform 66′ includes a telescopic member 670. The telescopic member 670 includes a first member 674 coupled to the platform 66′ and a second member 678 movable relative to the first member 674. The second member 678 includes a coupler 682. The second member 674 is movable relative to the first member 674 to adjust a position of the coupler 682.

The coupler 682 includes a first wall or plate 686 coupled to the second member 678 and a second wall or plate 690 coupled to the second member 678. The first and second walls 686, 690 are spaced apart from one another. A pin or post 694 extends between the first and second walls 686, 690. The pin 694 is spaced apart from a surface of the second member 678 of the telescopic member 670 by a gap. The first and second walls 686, 690 include through holes 698 that are aligned with one another. The coupler 682 (and specifically the walls 686, 690 thereof) defines a second interface that is complementary to the first interface of the frame 404.

In the illustrated embodiment, the first interface defined by the projection 564 of the frame 404 is a male interface and the second interface defined by the coupler 682 is a female interface. Accordingly, the projection 564 is receivable by the coupler 682. In particular, the projection 564 is receivable between the first wall 686 and the second wall 690 such that the recess 568 of the projection 564 receives the pin 694 and the through hole 572 of the projection 564 is aligned with the through holes 698 of the first and second walls 686, 690. A fastener 714 (e.g., a pin) removably couples the frame to the platform 66′. In particular, the fastener 714 extends through the through holes 698 of the first and second walls 686, 690 and the through hole 572 of the projection 564. Accordingly, the coupler 682 is able to be quickly and easily coupled to the frame 404 via the fastener 714.

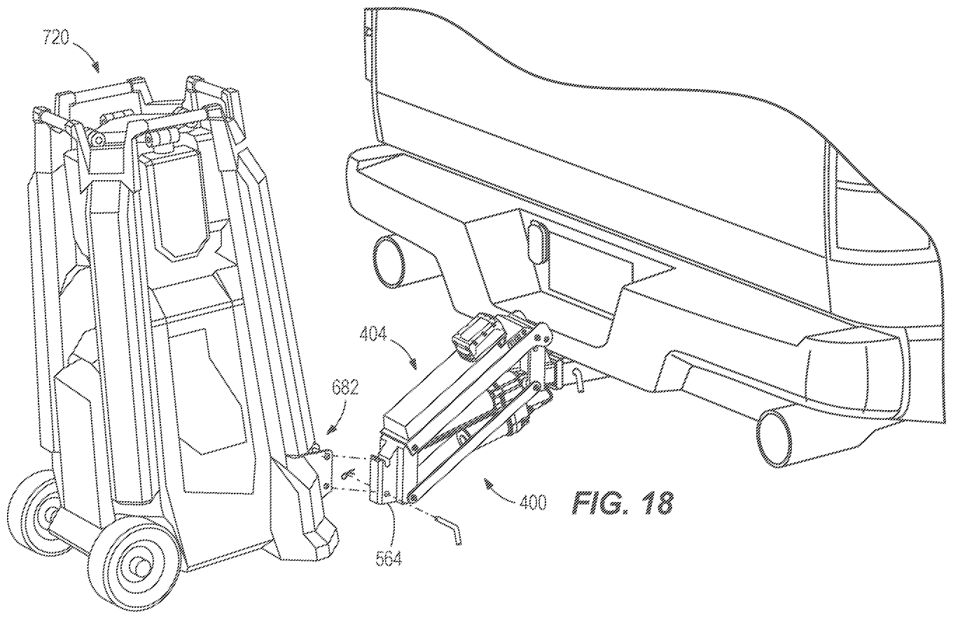

Although not shown in detail, the coupler 682 may be included on a power tool 720 (FIGS. 18-20) such that the platform 66′ can be removed and replaced with the power tool 720. In the illustrated embodiment, the power tool 720 is a tower light, but in other embodiments, the power tool 720 may be a power trowel, a plate compactor, a cable puller, a cart for a cut off saw, a lawn mower, or any other suitable power tool that is equipped with wheels or could be equipped with an auxiliary wheel assembly.

In other embodiments, the frame 404 may include the coupler 582 (and therefore a second, female interface), while the platform 66′ or the power tool 720 may include the projection 564 (and therefore the first, male interface).

In operation, to lower the projection 564 of the frame 404 from an elevated position (FIG. 15) to a lowered position (FIG. 14), a user operates controls on the user interface to activate the electric motor 630, which receives electrical current from the battery pack 126. The electric motor 630 provides torque to the threaded rod 642 to rotate the threaded rod 642 in a first rotational direction. As the threaded rod 642 rotates, the threads of the threaded rod 642 cooperate with the threads of the threaded aperture 662 in the insert 640 such that the insert 640 moves in a first linear direction and the extensible rod 638 is retracted into the housing 610 and toward the first frame portion 408. As the extensible rod 638 moves toward the first frame portion 408, the first, second, and third segments 470a, 470b, 478 are able to pivot relative to the second segment 420 of the first frame portion 408 and the fourth segment 482 of the second frame portion 412, such that the fourth segment 482 (and therefore the projection 564) moved downward relative to the first frame portion 408 and the ground. When the extensible rod 638 is in a retracted position, the extensible rod 638 extends from the housing by a first distance and the first end 540 of the fourth segment 482 of the second frame portion 412 is positioned above the ground by a second distance. When the extensible rod 638 is in the retracted position, the platform 66′ may be at or near the grounded position. A user may place cargo, objects, or tools onto the platform 66′ when the extensible rod 638 is in the retracted position. Further, the first ramp 114′ and/or the second ramp 118′ may be adjusted from the stowed position to the deployed position when the platform 66′ is at or near the grounded position to facilitate loading cargo, objects, or tools onto the platform 66′. Alternatively, when the extensible rod 638 is in the retracted position, the power tool 720 may be coupled to or released from the frame 404.

Similarly, to raise the projection 564 of the frame 404 from the lowered position, the user operates controls on the user interface to re-activate the electric motor 630. The electric motor 630 provides torque to the threaded rod 642 to rotate the threaded rod 642 in a second rotational direction that is opposite the first rotational direction. As the threaded rod 642 rotates, the threads of the threaded rod 642 cooperate with the threads of the threaded aperture 662 in the insert 640 such that the insert 640 moves in a second linear direction, opposite the first linear direction, and the extensible rod 638 is extended from the housing 610 and away from the first frame portion 408. As the extensible rod 638 moves away from the first frame portion 408, the first, second, and third segments 470a, 470b, 478 are able to pivot relative to the second segment 420 of the first frame portion 408 and the fourth segment 482 of the second frame portion 412, such that the fourth segment 482 (and therefore the projection 564) moved upward relative to the first frame portion 408 and the ground. When the extensible rod 638 is in an extended position, the extensible rod 638 extends from the housing 610 by a third distance and the first end 540 of the fourth segment 482 of the second frame portion 412 is positioned above the ground by a fourth distance such that the second frame portion 412 is in the elevated position. The third distance is greater than the first distance, and the fourth distance is greater than the second distance. When the extensible rod 638 is in the extended position, the platform 66′ or the power tool 720, whichever is attached, may be at the desired height (e.g., 12 inches). Once the platform 66′ reaches the desired height (e.g., 12 inches), the user deactivates the electric motor 630 via the user interface 162 to maintain the platform 66′ or tool 720 in the elevated position.

Although the invention has been described in detail with reference to certain preferred embodiments, variations and modifications exist within the scope and spirit of one or more independent aspects of the invention as described.

Various features of the invention are set forth in the following claims.

What is claimed is:

1. A cargo carrier releasably coupled to a hitch of a vehicle, the cargo carrier comprising:
a frame including a first frame portion releasably coupled to the hitch and a second frame portion that is movable relative to the first frame portion; and
a lifting assembly for alternatively raising and lowering the second frame portion relative to a grounded position, the lifting assembly including
an electric motor that receives electrical current from a power source, and
a drive mechanism driven by the electric motor to translate the second frame portion relative to the first frame portion to alternatively raise and lower the second frame portion relative to the grounded position,
wherein the second frame portion is alternately connectable to a platform upon which cargo is storable and a power tool directly supported by the second frame portion without the platform.

2. The cargo carrier of claim 1, wherein the power source is a battery pack that is removable and interchangeable for use with a plurality of power tools in a power tool system all configured to use the battery pack.

3. The cargo carrier of claim 1, wherein the drive mechanism includes an insert defining a threaded aperture and a threaded rod threadably engaged with the threaded aperture of the insert.

4. The cargo carrier of claim 3, wherein the threaded rod is configured to rotate and the insert is configured to translate relative to the first frame portion as the threaded rod rotates to allow the second frame portion to translate relative to the first frame portion to raise and lower the platform relative to the grounded position.

5. The cargo carrier of claim 1, wherein the second frame portion defines a first interface, wherein each of the platform and the power tool includes a coupler having a second interface that is complementary to the first interface of the frame, and wherein a fastener removably couples the first interface of the frame to the second interface of the coupler.

6. A cargo carrier releasably coupled to a hitch of a vehicle, the cargo carrier comprising:
a frame including a first frame portion releasably coupled to the hitch and a second frame portion that is movable relative to the first frame portion;
a platform coupled to the second frame portion upon which cargo is storable;
a battery pack; and
a lifting assembly for alternatively raising and lowering the second frame portion and the platform relative to a grounded position, the lifting assembly including
an electric motor that receives electrical current from the battery pack, and
a drive mechanism driven by the electric motor to move the second frame portion relative to the first frame portion to alternatively raise and lower the platform relative to the grounded position.

7. The cargo carrier of claim 6, wherein the battery pack is removable and interchangeable for use with a plurality of power tools in a power tool system all configured to use the battery pack.

8. The cargo carrier of claim 6, wherein the drive mechanism includes an insert defining a threaded aperture and a threaded rod threadably engaged with the threaded aperture of the insert, and wherein the threaded rod is configured to rotate and the insert is configured to translate relative to the first frame portion as the threaded rod rotates to allow the second frame portion to translate relative to the first frame portion to raise and lower the platform relative to the grounded position.

9. The cargo carrier of claim 6, wherein the drive mechanism includes a hydraulic system.

10. The cargo carrier of claim 6, wherein the first frame portion and the second frame portion collectively define a four-bar linkage.

11. The cargo carrier of claim 6, wherein the platform includes a ramp that is adjustable between a deployed position, in which the ramp extends toward a support surface upon which the vehicle is located, and a stowed position.

12. The cargo carrier of claim 11, wherein the ramp is pivotable between the deployed position and the stowed position.

13. The cargo carrier of claim 6, wherein the lifting assembly further includes
a housing in which the electric motor is located, and
a user interface on the housing having user controls to selectively operate the electric motor to alternatively raise and lower the platform relative to the grounded position.

14. The cargo carrier of claim 6, wherein the second frame portion defines a first interface, wherein the platform includes a coupler including a second interface that is complementary to the first interface of the frame, and wherein a fastener removably couples the first interface of the frame to the second interface of the coupler.

15. A cargo carrier releasably coupled to a hitch of a vehicle, the cargo carrier comprising:
a frame releasably coupled to the hitch, the frame including
a first segment that is fixed relative to the hitch;
a second segment that is pivotably coupled to the first segment;
a third segment that is pivotably coupled to the first segment; and
a fourth segment that is pivotably coupled to the second segment and the third segment, the fourth segment being vertically movable relative to the first segment during which the second and third segments are maintained in a parallel relationship; and
a lifting assembly for alternatively raising and lowering the fourth segment relative to a grounded position, the lifting assembly including
an electric motor that receives electrical current from a power source, and
a drive mechanism driven by the electric motor to translate the fourth segment relative to the first segment to alternatively raise and lower the fourth segment relative to the grounded position,
wherein the fourth segment is alternately connectable to a platform upon which cargo is storable and a power tool directly supported by the second frame portion without the platform.

16. The cargo carrier of claim 15, wherein the power source is a battery pack that is removable and interchangeable for use with a plurality of power tools in a power tool system all configured to use the battery pack.

17. The cargo carrier of claim 15, wherein the drive mechanism includes an insert defining a threaded aperture and a threaded rod threadably engaged with the threaded aperture of the insert.

18. The cargo carrier of claim 17, wherein the threaded rod is configured to rotate and the insert is configured to translate relative to the fourth segment as the threaded rod rotates to allow the fourth segment to translate relative to the first segment to raise and lower the fourth segment relative to the grounded position.

19. The cargo carrier of claim 15, wherein the fourth segment defines a first interface, wherein the at least one of the platform and the power tool includes a coupler having a second interface that is complementary to the first interface of the frame, and wherein a fastener removably couples the first interface of the frame to the second interface of the coupler.

20. The cargo carrier of claim 19, wherein
the first interface is defined by a projection having a recess and a through hole, the second interface is defined by a first wall, a second wall spaced apart from the second wall, and a pin extending between the first wall and the second wall, the first wall and the second wall including aligned through holes,
the projection is receivable between the first wall and the second wall such that the recess receives the pin and the through hole of the projection is aligned with the aligned through holes of the first wall and second wall, and
wherein the fastener extends through the aligned through holes of the first wall and the second wall and the through hole of the projection.
